(19) United States
(12) Patent Application Publication
(10) Pub. No.: US 2025/0384545 A1
(43) Pub. Date: Dec. 18, 2025

(54) METHOD AND DEVICE FOR GENERATING VEHICLE PAINT SURFACE DATA

(71) Applicant: HYUNDAI AUTOEVER CORP., Seoul (KR)

(72) Inventors: Dong Hoon Park, Seoul (KR); Ga Eun Na, Seoul (KR); Nu Lee Song, Seoul (KR); Jae Yung Lee, Seoul (KR); Jae Hong Eom, Seoul (KR)

(73) Assignee: HYUNDAI AUTOEVER CORP., Seoul (KR)

(21) Appl. No.: 19/239,141

(22) Filed: Jun. 16, 2025

(30) Foreign Application Priority Data
Jun. 14, 2024 (KR) 10-2024-0077349

(51) Int. Cl. G06T 7/00; G06T 7/40

(52) U.S. Cl. CPC G06T 7/0008; G06T 7/40; G06T 2207/30156

(57) ABSTRACT

A method of generating vehicle paint surface data includes: obtaining first process paint surface images of vehicles in a first process among processes for producing the vehicles. The method also includes storing, as first process defect images, images that contain paint surface defects, from among the first process paint surface images. The method additionally includes obtaining second process paint surface images of the vehicles in a second process that is performed after the first process. The method also includes generating second process defect images by performing a style transfer on the first process defect images to match a paint surface style of the second process, by using some or all of the second process paint surface images.

### CROSS-REFERENCE TO RELATED APPLICATION

This application claims the benefit of and priority to Korea Patent Application No. 10-2024-0077349, filed on Jun. 14, 2024, the entire contents of which are hereby incorporated herein by reference.

### FIELD OF TECHNOLOGY

Embodiments of the present disclosure relate to data augmentation.

### BACKGROUND

A vehicle painting process may include a plurality of operations. In general, a vehicle painting process may include a pre-treatment process, an electro-coating process, a middle coating process, a top coating process, a drying and curing process, an inspection and correction process, a finishing and protection process, and the like.

In the pre-treatment process, cleaning is performed to remove oil, dust, rust, and the like from a vehicle surface. In this operation, chemicals or detergents may be used. In addition, in the pre-treatment process, a degreasing operation may be performed to completely remove oil and impurities by using an alkaline degreasing agent or an acidic degreasing agent. Furthermore, in the pre-treatment process, a phosphating operation, which involves immersing or spraying the vehicle with a phosphate solution, may be performed, and through this operation, a phosphate coating may be formed on the vehicle surface, providing effects such as corrosion prevention and improved paint adhesion.

In the electro-coating (E-coat) process, an operation may be performed where paint is uniformly applied to the vehicle body through an electric field, with the vehicle body acting as a cathode and the paint as an anode, followed by curing in an oven. This electro-coating process may provide a uniform anti-rust coating across the entire vehicle body.

In the middle coating process, an operation may be performed to smooth the vehicle paint surface and enhance adhesion, such that paint used in the top coating process may adhere well to the vehicle body. The paint used in the middle coating process, often referred to as a primer surfacer, may fill defects on the vehicle paint surface and enhance the durability of the vehicle body. In addition, anti-rust paint is used in the middle coating process, which may protect the vehicle body from rust. Furthermore, the paint in the middle coating process is applied to a uniform thickness, which may improve the quality of the final coating.

In the top coating process, the final color of the vehicle may be determined. In this process, a color basecoat and a clearcoat may be used. Here, the basecoat, which is paint that determines the final color of the vehicle, may impart various colors and effects to the vehicle. The clearcoat, which is transparent paint, may protect the basecoat and enhance the gloss of the exterior of the vehicle. The paint applied during the top coating process may serve to protect the vehicle body from external elements, providing features such as ultraviolet protection and scratch prevention.

After the top coating process, the vehicle painting process may be completed by performing the drying and curing process, the inspection and correction process, the finishing and protection process, and the like.

The middle coating process involves filling defects on the vehicle paint surface with paint and smoothing the surface. Consequently, a rigorous inspection for defects on the vehicle paint surface is essential in the middle coating process. To meet this high demand for inspection, numerous vision inspection devices capable of automatically performing defect inspections in middle coating processes have recently been developed, and accordingly, a substantial amount of defect image data is available for training artificial intelligence networks for middle coating processes.

However, other processes, such as the top coating process, currently rely on manual devices, such as devices for naked-eye visual inspection, due to a relative lack of vehicle paint surface data.

The discussions in this section are intended merely to provide background information and do not constitute an admission of prior art.

### SUMMARY

An embodiment of the present disclosure provides a technology for generating data for a data-scarce process by using data from a data-abundant process. Another embodiment of the present disclosure is provides a technology for generating data for a top coating process by using data from a middle coating process, specifically in the context of vehicle paint surface data.

According to an embodiment, a method of generating vehicle paint surface data is provided. The method includes obtaining first process paint surface images of vehicles in a first process among processes for producing the vehicles. The method also includes storing, as first process defect images, images that contain paint surface defects, from among the first process paint surface images. The method additionally includes obtaining second process paint surface images of the vehicles in a second process that is performed after the first process. The method further includes generating second process defect images by performing a style transfer on the first process defect images to match a paint surface style of the second process, by using some or all of the second process paint surface images.

Generating the second process defect images may include performing the style transfer on the first process defect images by using normal images that do not contain the paint surface defects, from among the second process paint surface images.

The first process and the second process may be painting processes, and vehicle painting of the second process may be performed after vehicle painting of the first process.

The first process may be a middle coating process, and the second process may be a top coating process.

The paint surface defects may correspond to at least one paint surface defect among scratches, dents, orange peel, pinholes, chips, drips, fish eyes, or blisters.

Generating the second process defect images may include using a style transfer network configured to receive, as input, a content image and a style image, and to generate a style-transferred content image based on the style image.

The style transfer network may include: an image encoder configured to generate a feature map from an input image; an Adaptive Instance Normalization (AdaIN) layer configured to generate a new feature map by combining a first feature map that is generated for the content image with a second feature map that is generated for the style image; and an image decoder configured to generate the style-transferred content image by transforming the new feature map into an image space.

The AdaIN layer may be further configured to apply statistical features of the style image to the content image while maintaining structural features of the content image.

The number of the first process paint surface images obtained for the vehicles may be greater than the number of the second process paint surface images obtained for the vehicles.

The first process paint surface images or the first process defect images may be obtained by a vision inspection device, and the second process paint surface images may be obtained by a device for naked-eye visual inspection.

The second process defect images may be used for machine learning of a vision inspection device configured to detect paint surface defects in the second process.

According to another embodiment, a device for generating vehicle paint surface data is provided. The device includes a first memory configured to store first process defect images that contain paint surface defects, from among first process paint surface images that are obtained for vehicles in a first process among processes for producing the vehicles. The device also includes a second memory configured to store some or all of second process paint surface images obtained for the vehicles in a second process that is performed after the first process. The device additionally includes a vehicle paint surface data generation unit configured to generate second process defect images by performing a style transfer on the first process defect images to match a paint surface style of the second process, by using some or all of the second process paint surface images.

The first process defect images may be stored in the first memory by a vision inspection device that is used for the first process.

Some of the second process paint surface images may be stored in the second memory based on a selection input.

The vehicle paint surface data generation unit may further be configured to generate the second process defect images by using a style transfer network configured to receive, as input, a content image and a style image, and to generate a style-transferred content image based on the style image.

The style transfer network may include: an image encoder configured to generate a feature map from an input image; an AdaIN layer configured to generate a new feature map by combining a first feature map that is generated for the content image with a second feature map that is generated for the style image; and an image decoder configured to generate the style-transferred content image by transforming the new feature map into an image space.

The vehicle paint surface data generation unit may be further configured to train the style transfer network by using a style loss and a content loss.

The style transfer network may be further configured to calculate the style loss by comparing a feature map that is extracted from the style image through the image encoder with another feature map that is extracted from the style-transferred content image.

The style transfer network may be further configured to calculate the content loss by comparing the new feature map with the other feature map.

The first process may be a middle coating process, and the second process may be a top coating process.

As described above, according to embodiments of the present disclosure, it is possible to generate data for a data-scarce process by using data from a data-abundant process. Furthermore, according to embodiments of the present disclosure, it is possible to generate data for a top coating process by using data from a middle coating process, specifically in the context of vehicle paint surface data.

### BRIEF DESCRIPTION OF THE DRAWINGS

In order to enhance understanding of the present disclosure by one having ordinary skill in the art, various example embodiments of the present disclosure are described below with reference to the accompanying drawings, in which:

FIG. 1 is a configuration diagram of a vehicle paint surface data generation system according to an embodiment;

FIG. 2 is a diagram illustrating a first process, according to an embodiment;

FIG. 3 illustrates examples of first process defect images obtained in a first process, according to an embodiment;

FIG. 4 is a diagram illustrating a second process, according to an embodiment;

FIG. 5 illustrates examples of second process defect images obtained in a second process, according to an embodiment;

FIG. 6 is a flowchart of a method of generating vehicle paint surface data, according to an embodiment;

FIG. 7 is a configuration diagram of a style transfer network, according to an embodiment; and

FIG. 8 is a configuration diagram of a vehicle paint surface data generation device, according to an embodiment.

### DETAILED DESCRIPTION

Hereinafter, some embodiments of the present disclosure are described in detail with reference to accompanying diagrams. It should be noted that in assigning reference numerals to components in the accompanying drawings, identical components are designated with the same reference numerals whenever possible, even when the components are illustrated in different drawings. Furthermore, in the description of the present disclosure, where it was determined that a detailed description of related known configurations or functions would obscure the gist of the present disclosure, the detailed description thereof has been omitted.

In addition, in describing components of the present disclosure, expressions such as “first”, “second”, “A”, “B”, “(a)”, or “(b)” may be used. These expressions are only intended to distinguish one component from another, and do not limit the nature, order, or sequence of the components. It should be understood that, when it is described that a first element is “connected,” “coupled,” or “joined” to a second element, the first element may be directly connected, coupled, or joined to the second element, or the first element may be connected, coupled, or joined to the second element with a third element connected, coupled, or joined therebetween.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

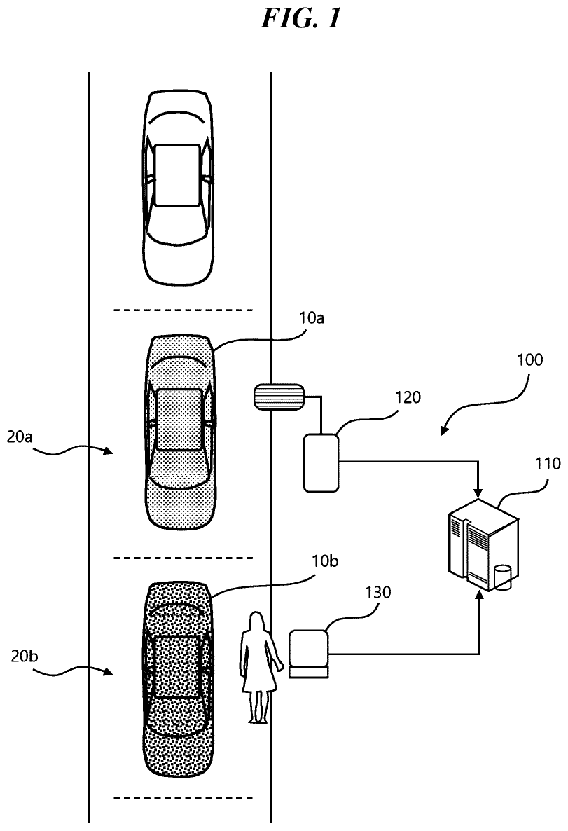

FIG. 1 is a configuration diagram of a vehicle paint surface data generation system according to an embodiment.

Referring to FIG. 1, a vehicle paint surface data generation system 100 may include a vehicle paint surface data generation device 110, a first process data obtaining device 120, a second process data obtaining device 130, and the like.

A vehicle may be produced through a plurality of processes. A paint surface of the vehicle may be completed through a plurality of processes.

The first process data obtaining device 120 may obtain paint surface images of first vehicles 10a undergoing a first process 20a among the plurality of processes. For convenience of description, the paint surface images obtained by the first process data obtaining device 120 are generally referred to herein as first process paint surface images.

The first process data obtaining device 120 may include a camera device for capturing images of the first vehicles 10a. In addition, the first process data obtaining device 120 may capture images of the paint surfaces of the first vehicles 10a by using the camera device, and may generate first process paint surface images.

The first process data obtaining device 120 may be an automated device. The first process data obtaining device 120 may generate (e.g., may automatically generate) first process paint surface images through a pre-designed algorithm or an artificial intelligence network having pre-determined parameter values.

The first process data obtaining device 120 may classify the first process paint surface images into normal images and defect images. For convenience of description, the normal images are generally referred to herein as first process normal images, and the defect images are generally referred herein to as first process defect images.

The first process data obtaining device 120 may classify the first process paint surface images into first process normal images and may first process defect images through a pre-designed algorithm or an artificial intelligence network having pre-determined parameter values.

In addition, defects in the first vehicles 10a associated with the first process defect images may be corrected through an additional process.

The second process data obtaining device 130 may obtain paint surface images of second vehicles 10b undergoing a second process 20b among the plurality of processes. For convenience of description, the paint surface images obtained by the second process data obtaining device 130 are generally referred herein to as second process paint surface images. In various embodiments, the second vehicles 10b may be the same as, or different from, the first vehicles 10a.

The second process data obtaining device 130 may include a camera device for capturing images of the second vehicles 10b. In addition, the second process data obtaining device 130 may capture images of the paint surfaces of the second vehicles 10b by using the camera device, and generate second process paint surface images.

The second process data obtaining device 130 may be a partially or fully manual device. The second process data obtaining device 130 may manually generate second process paint surface images based on an operator's selection input.

The second process data obtaining device 130 may classify the second process paint surface images into normal images and defect images. For convenience of description, the normal images are generally referred to herein as second process normal images, and the defect images are generally referred to herein as second process defect images.

The second process data obtaining device 130 may manually classify the second process paint surface images into second process normal images and second process defect images, based on the operator's selection input.

The number of first process paint surface images generated by the first process data obtaining device 120 may be greater than the number of second process paint surface images generated by the second process data obtaining device 130. Alternatively, the number of first process paint surface defect images may be greater than the number of second process paint surface defect images or the number of second process paint surface normal images.

The vehicle paint surface data generation device 110 may additionally generate second process defect images by performing a style transfer on the first process paint surface defect images to match a paint surface style of the second process, by using some or all of the second process paint surface images.

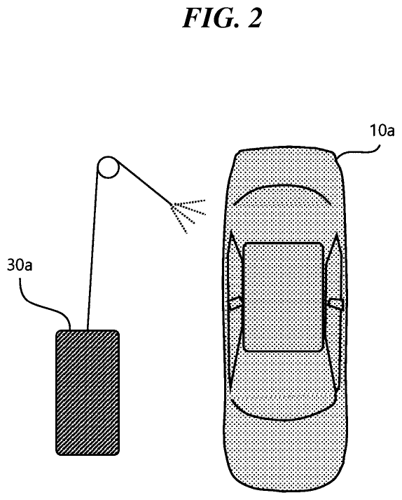

FIG. 2 is a diagram illustrating a first process according to an embodiment.

Referring to FIG. 2, the first process may be a middle coating process. In the middle coating process, paint sprayed from a first painting device 30a may be applied to a paint surface of the first vehicle 10a.

The middle coating process may serve to smooth a vehicle surface and prepare it such that paint may be uniformly applied in a top coating process. The paint used in the middle coating process is referred to as a primer surfacer, and this paint may perform various functions.

First, the primer surfacer may serve to fill fine defects on the vehicle surface. It fills small scratches or grooves that may occur during a painting process, thereby making the surface smooth. As a result, the final paint surface may become smoother and more uniform.

In addition, the primer surfacer may serve to increase the adhesion of the top coat paint. If the top coat paint does not adhere well to the vehicle body, the paint may peel off easily, and the paint used in the middle coating process may help ensure good adhesion for the top coat paint. This may serve to enhance the aesthetic quality of the vehicle and improve the durability of the paint.

In the middle coating process, an inspection for defects on the paint surface may be rigorously performed. This is because even a small defect on the paint surface may significantly affect the final painting result. As the demand for such inspections increases, vision inspection devices capable of automatically performing defect inspections in a middle coating process have recently been developed. This device contributes to enhancing paint quality by scanning a vehicle surface and accurately detecting even fine defects.

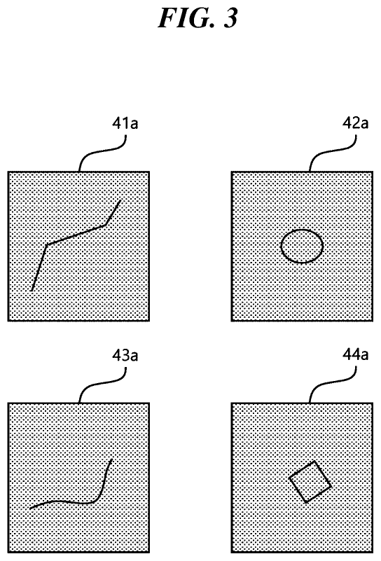

FIG. 3 illustrates examples of first process defect images obtained in a first process, according to an embodiment.

Referring to FIG. 3, paint surface defects may appear in various forms, such as a scratch 41a, a dent 43a, orange peel, pinholes, a chip 44a, drips, fish eyes, or a blister 42a.

A scratch defect is a flaw in the form of a thin, long line, and may be a mark caused by physically scratching the surface. A scratch defect may occur when a work tool or an operator inadvertently scratches a vehicle body surface during a painting operation.

A dent defect may be a flaw in which the surface is locally indented. A dent defect may occur when a metal surface becomes indented due to impact or pressure during a vehicle body assembly process.

An orange peel defect is a defect characterized by an uneven surface texture similar to an orange peel. An orange peel defect may occur when paint is not uniformly distributed during painting, or when the viscosity of paint and drying conditions are inappropriate.

A pinhole defect is a defect characterized by the appearance of numerous significantly small holes on the surface. A pinhole defect may occur when air bubbles contained in paint burst after painting, leaving small holes.

A chip defect may be a mark where a small part of a paint surface has peeled or chipped away. A chip defect may occur when small particles or debris collide with the vehicle body during a curing process after painting.

A drip defect may be a mark formed when paint flows down and then hardens. A drip defect may occur when too much paint is used during painting or when the painting angle is inappropriate.

A fish eye defect is a defect characterized by small, circular marks, resembling fish eyes, on the paint surface. A fish eye defect may occur when silicone contaminants, oil, wax, or the like, are present on the paint surface.

A blister defect is a defect where the paint surface swells up, resembling a small blister. A blister defect may occur when moisture or air bubbles become trapped under the paint after painting, causing it to swell.

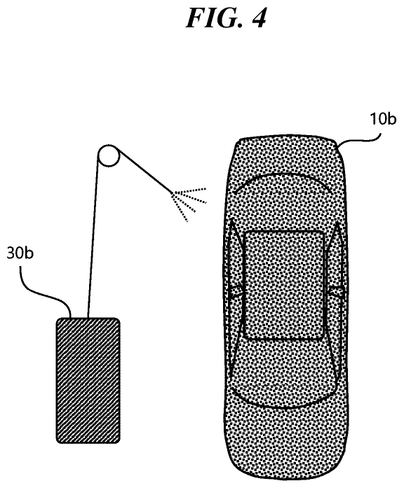

FIG. 4 is a diagram illustrating a second process according to an embodiment.

Referring to FIG. 4, the second process may be a top coating process. The top coating process may be a vehicle painting process performed after the middle coating process.

In the top coating process, paint sprayed from a second painting device 30b may be applied to a paint surface of the second vehicle 10b.

The top coating process ultimately completes the exterior appearance and protective function of the vehicle in the vehicle painting process. This process includes a basecoat operation and a clearcoat operation.

First, the basecoat operation determines the final color of the vehicle. A basecoat is applied in various colors and serves to express the design and brand image of the vehicle. In this operation, it is necessary to uniformly and evenly distribute the paint, and to ensure that there is no imbalance in color or gloss. The basecoat is typically applied by a spray method, and after application, it is dried for a specific period. In this process, uniformity of color and smoothness of the surface may be ensured.

The next operation is clearcoat application. A clearcoat is a transparent protective layer that serves to protect the basecoat and impart gloss to the vehicle. This layer serves to further enhance the gloss of the exterior of the vehicle and protect the vehicle from the external environment. The clearcoat has an ultraviolet (UV) blocking function, thereby preventing color fading due to sunlight, and protects the paint surface from small scratches or contaminants. The clearcoat is also applied by a spray method, and after application, undergoes a curing process in an oven.

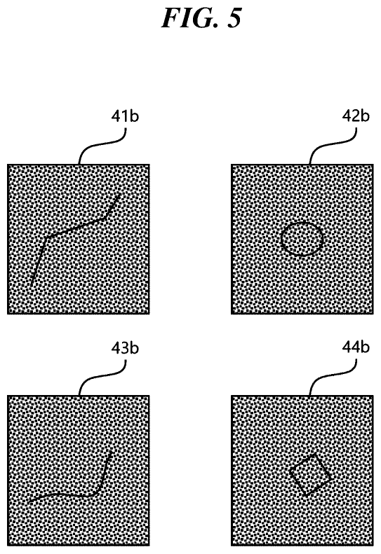

FIG. 5 illustrates examples of second process defect images obtained in a second process, according to an embodiment.

Referring to FIG. 5, paint surface defects may appear in various forms, such as a scratch 41b, a dent 43b, orange peel, pinholes, a chip 44b, drips, fish eyes, or a blister 42b.

These paint surface defects in the second process may be similar to the paint surface defects in the first process described above with reference to FIG. 3. Because the second process is a subsequent process to the first process and the paint application methods used in the respective processes are similar, similar defects may appear in both the first process and the second process.

However, as may be seen by comparing the defect images of FIGS. 3 and 5, first process defect images and second process defect images may have different image styles. The style depends on the material of the applied paint as well as on the image capturing environment (e.g., lighting or air turbidity) in the first process and the second process.

A vehicle paint surface data generation device according to an embodiment may apply the style of second process paint surface images to first process defect images through a style transfer network using an adversarial learning method, thereby additionally generating numerous defect images for the data-scarce second process.

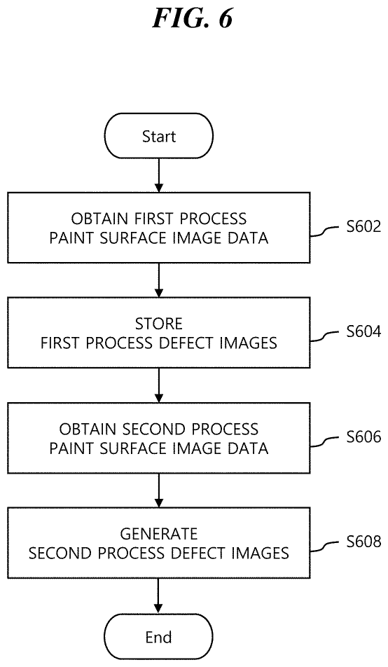

FIG. 6 is a flowchart of a method of generating vehicle paint surface data according to an embodiment.

Referring to FIG. 6, in an operation S602, a vehicle paint surface data generation device (hereinafter, referred to as the device) may obtain first process paint surface images of vehicles in a first process among processes for producing vehicles.

In an operation S604, the device may store, as first process defect images, images containing paint surface defects from among the first process paint surface images.

In an operation S606, the device may obtain second process paint surface images of vehicles in a second process that is performed after the first process.

In an operation S608, the device may generate second process defect images by performing a style transfer on the first process defect images to match a paint surface style of the second process, by using some or all of the second process paint surface images.

When generating the second process defect images in the operation S608, the device may perform a style transfer on the first process defect images by using normal images, which do not contain paint surface defects, from among the second process paint surface images.

In an embodiment, the first process and the second process are painting processes, and the vehicle painting of the second process may be performed after the vehicle painting of the first process. For example, the first process may be a middle coating process, and the second process may be a top coating process.

The paint surface defect may correspond to at least one paint surface defect among scratches, dents, orange peel, pinholes, chips, drips, fish eyes, or blisters, but is not limited thereto.

The number of first process paint surface images obtained for vehicles may be greater than the number of second process paint surface images obtained for the vehicles. In addition, the first process paint surface images or the first process defect images may be obtained by a vision inspection device, and the second process paint surface images may be obtained by a device for naked-eye visual inspection. In an embodiment, the device for naked-eye visual inspection may be a device in which an image is captured or selected based on an operator's selection input.

The second process defect images may be used for the machine learning of a vision inspection device that detects paint surface defects in the second process.

When generating the second process defect images in the operation S608, the device may use a style transfer network configured to receive, as input, a content image and a style image, and to generate a style-transferred content image based on the style image.

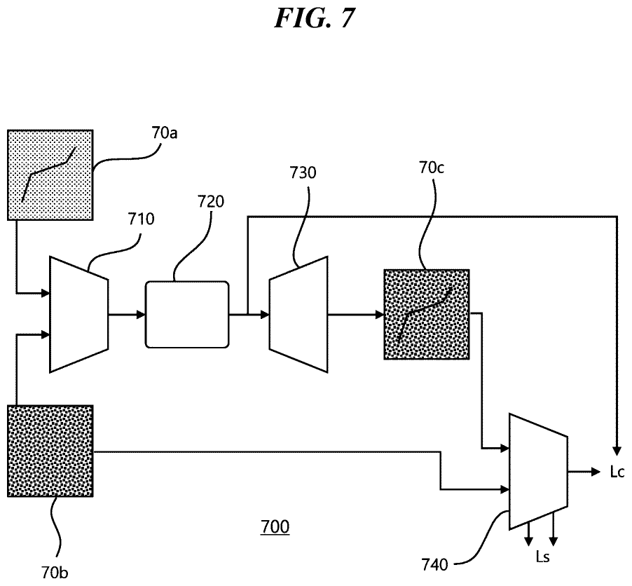

FIG. 7 is a configuration diagram of a style transfer network according to an embodiment.

Referring to FIG. 7, a style transfer network 700 may include a first image encoder 710, an Adaptive Instance Normalization (AdaIN) layer 720, an image decoder 730, a second image encoder 740, and the like.

The first image encoder 710 and the second image encoder 740 may generate a feature map from an input image.

For example, the first image encoder 710 may extract a first feature map from a first process defect image 70a. In addition, the first image encoder 710 may extract a second feature map from a second process normal image 70b. In an embodiment, the first process defect image 70a may be used as a content image in the style transfer network 700, and the second process normal image 70b may be used as a style image in the style transfer network 700.

The AdaIN layer 720 may generate a new feature map by combining the first feature map with the second feature map. The AdaIN layer 720 may generate a new feature map by applying statistical features of the style image to the content image while maintaining structural features of the content image.

In addition, the image decoder 730 may generate a second process defect image 70c by transforming the new feature map, which has been generated by the AdaIN layer 720, into an image space. Here, the second process defect image 70c may be a style-transferred content image generated by the style transfer network 700.

The style transfer network 700 may train its internal parameters by using a style loss Ls and a content loss Lc.

The second image encoder 740 may extract a feature map from a style image, for example, the second process normal image 70b. In addition, the second image encoder 740 may extract another feature map from a style-transferred content image, for example, the second process defect image 70c. Then, the style transfer network 700 may calculate the style loss Ls by comparing the feature map with the other feature map.

In addition, the style transfer network 700 may calculate the content loss Lc by comparing the other feature map generated by the second image encoder 740, with the new feature map generated by the AdaIN layer 720.

In addition, the style transfer network 700 may train its internal parameters such that the style loss Ls and the content loss Lc decrease. This training process may be performed by a device external to the style transfer network 700.

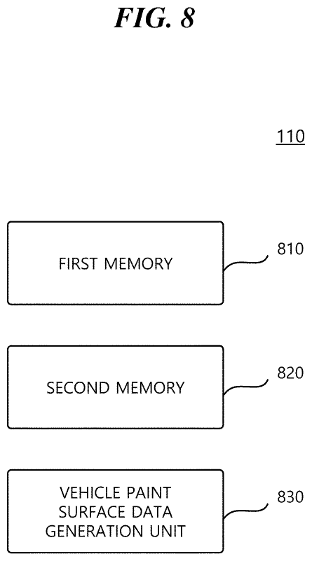

FIG. 8 is a configuration diagram of a vehicle paint surface data generation device according to an embodiment.

Referring to FIG. 8, the vehicle paint surface data generation device 110 may include a first memory 810, a second memory 820, a vehicle paint surface data generation unit 830, and the like.

The first memory 810 may store first process defect images, which contain paint surface defects, from among first process paint surface images obtained for vehicles in a first process among processes for producing vehicles.

In an embodiment, the first process defect images may be stored (e.g., may be automatically stored) in the first memory 810 by a vision inspection device used for the first process.

The second memory 820 may store some or all of second process paint surface images obtained for vehicles in a second process that is performed after the first process.

In an embodiment, some of the second process paint surface images may be stored in the second memory 820 based on a selection input.

The vehicle paint surface data generation unit 830 may generate second process defect images by using a style transfer network configured to receive, as input, a content image and a style image, and to generate a style-transferred content image based on the style image.

In an embodiment, the style transfer network may include an image encoder configured to generate a feature map from an input image, an AdaIN layer configured to generate a new feature map by combining a first feature map that is generated for a content image with a second feature map that is generated for a style image, and an image decoder configured to generate a style-transferred content image by transforming the new feature map into an image space.

The vehicle paint surface data generation unit 830 may train the style transfer network by using a style loss and a content loss.

The style transfer network may calculate a style loss by comparing a feature map that is extracted from a style image through the image encoder with another feature map that is extracted from a style-transferred content image. In addition, the style transfer network may calculate a content loss by comparing the new feature map with the other feature map.

In an embodiment, the first process may be a middle coating process, and the second process may be a top coating process.

As described above, according to an embodiment, it is possible to generate data for a data-scarce process by using data from a data-abundant process. Furthermore, according to an embodiment, it is possible to generate data for a top coating process by using data from a middle coating process, specifically in the context of vehicle paint surface data.

The terms such as “include,” “comprise,” or “have” described above mean that the corresponding component may be inherent as long as there is no particular opposing recitation, and thus, it should be interpreted that other components may be further included rather than excluded. All terms used herein, including technical and scientific terms, have the same meaning as commonly understood by those of ordinary skill in the art, unless defined otherwise. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

The above description merely explains the technical idea of the present disclosure and the present disclosure may be changed and modified in various ways without departing from the scope of the present disclosure by those of ordinary skill in the art. Accordingly, the embodiments described herein are provided not to limit, but to merely explain the technical idea of the present disclosure, and the technical idea of the present disclosure is not limited by the embodiments. The scope of the present disclosure should be construed by the following claims, and all technical ideas within the equivalent scope should be construed as being included in the scope of the present disclosure.

What is claimed is:

1. A method of generating vehicle paint surface data, the method comprising:
obtaining first process paint surface images of vehicles in a first process among processes for producing the vehicles;
storing, as first process defect images, images that contain paint surface defects, from among the first process paint surface images;
obtaining second process paint surface images of the vehicles in a second process that is performed after the first process; and
generating second process defect images by performing a style transfer on the first process defect images to match a paint surface style of the second process, by using some or all of the second process paint surface images.

2. The method of claim 1, wherein generating the second process defect images comprises performing the style transfer on the first process defect images by using normal images that do not contain the paint surface defects, from among the second process paint surface images.

3. The method of claim 1, wherein:
the first process and the second process are painting processes; and
vehicle painting of the second process is performed after vehicle painting of the first process.

4. The method of claim 1, wherein:
the first process is a middle coating process; and
the second process is a top coating process.

5. The method of claim 1, wherein the paint surface defects correspond to at least one paint surface defect among scratches, dents, orange peel, pinholes, chips, drips, fish eyes, or blisters.

6. The method of claim 1, wherein generating the second process defect images includes using a style transfer network configured to receive, as input, a content image and a style image, and to generate a style-transferred content image based on the style image.

7. The method of claim 6, wherein the style transfer network comprises:
an image encoder configured to generate a feature map from an input image;
an Adaptive Instance Normalization (AdaIN) layer configured to generate a new feature map by combining a first feature map that is generated for the content image with a second feature map that is generated for the style image; and
an image decoder configured to generate the style-transferred content image by transforming the new feature map into an image space.

8. The method of claim 7, wherein the AdaIN layer is further configured to apply statistical features of the style image to the content image while maintaining structural features of the content image.

9. The method of claim 1, wherein a number of the first process paint surface images obtained for the vehicles is greater than a number of the second process paint surface images obtained for the vehicles.

10. The method of claim 1, wherein:
the first process paint surface images or the first process defect images are obtained by a vision inspection device; and
the second process paint surface images are obtained by a device for naked-eye visual inspection.

11. The method of claim 1, wherein the second process defect images are used for machine learning of a vision inspection device configured to detect paint surface defects in the second process.

12. A device for generating vehicle paint surface data, the device comprising
a first memory configured to store first process defect images that contain paint surface defects, from among first process paint surface images that are obtained for vehicles in a first process among processes for producing the vehicles;
a second memory configured to store some or all of second process paint surface images obtained for the vehicles in a second process that is performed after the first process; and
a vehicle paint surface data generation unit configured to generate second process defect images by performing a style transfer on the first process defect images to match a paint surface style of the second process, by using some or all of the second process paint surface images.

13. The device of claim 12, wherein the first process defect images are stored in the first memory by a vision inspection device that is used for the first process.

14. The device of claim 12, wherein some of the second process paint surface images are stored in the second memory based on a selection input.

15. The device of claim 12, wherein the vehicle paint surface data generation unit is further configured to generate the second process defect images by using a style transfer network configured to receive, as input, a content image and a style image, and to generate a style-transferred content image based on the style image.

16. The device of claim 15, wherein the style transfer network comprises:
an image encoder configured to generate a feature map from an input image;
an Adaptive Instance Normalization (AdaIN) layer configured to generate a new feature map by combining a first feature map that is generated for the content image with a second feature map that is generated for the style image; and
an image decoder configured to generate the style-transferred content image by transforming the new feature map into an image space.

17. The device of claim 16, wherein the vehicle paint surface data generation unit is further configured to train the style transfer network by using a style loss and a content loss.

18. The device of claim 17, wherein the style transfer network is further configured to calculate the style loss by comparing a feature map that is extracted from the style image through the image encoder with another feature map that is extracted from the style-transferred content image.

19. The device of claim 18, wherein the style transfer network is further configured to calculate the content loss by comparing the new feature map with the other feature map.

20. The device of claim 12, wherein:
the first process is a middle coating process; and
the second process is a top coating process.
